(19) United States
(12) Patent Application Publication
(10) Pub. No.: US 2023/0158813 A1
(43) Pub. Date: May 25, 2023

(54) ADJUSTING DISTANCE BETWEEN PRINT MEDIA AND PRINTHEAD

(71) Applicant: Hewlett-Packard Development Company, L.P., Spring, TX (US)

(72) Inventors: Isidoro MAYA AGUDO, Sant Cugat del Valles (ES); Ricardo SANCHIS ESTRUCH, Sant Cugat del Valles (ES); Jordi ALBERT GINE, Sant Cugat del Valles (ES)

(73) Assignee: Hewlett-Packard Development Company, L.P., Spring, TX (US)

(21) Appl. No.: 17/996,904

(22) PCT Filed: Apr. 23, 2020
(86) PCT No.: PCT/US2020/029508

§ 371 Date: Oct. 21, 2022

(51) Int. Cl. B41J 11/20; B41J 2/01; B41J 25/308; B41J 29/393

(52) U.S. Cl. CPC B41J 11/20; B41J 2/01; B41J 25/308; B41J 29/393

(57) ABSTRACT

Examples relate to adjusting systems to adjust a distance between a print medium support and a printhead. The adjusting system comprises a support structure and a print medium input beam and a print medium output movably coupled to the support structure to support the print medium support. The adjusting system further comprises an input and an output beam driving assembly to respectively move the print medium input and output relative to the support structure between an upper and a lower end including a home position. In addition, the adjusting system comprises an input beam sensor assembly and an output beam sensor assembly comprising a reference sensor and a relative sensor.

### BACKGROUND

A printing system may include a pen or a printhead with a plurality of nozzles that deliver print agent onto a print medium so as to print an image. In printing processes, a distance between the printhead and the print medium, known as the printhead-to-print medium spacing (also known as pen-to-paper spacing, PPS), may influence print quality.

### BRIEF DESCRIPTION OF THE DRAWINGS

Various example features will be apparent from the detailed description which follows, taken in conjunction with the accompanying drawings, wherein:

FIG. 1 illustrates a side view of a printing system according to an example of the present disclosure and a zoom-in view schematically representing a non-transitory machine-readable storage medium according to an example of the present disclosure.

FIG. 2 illustrates an isometric view of an adjusting system according to an example of the present disclosure.

FIG. 3 illustrates a zoom-in view of a portion of the adjusting system of FIG. 2.

FIG. 4 illustrates a driving assembly and a sensor assembly according to an example of the present disclosure.

FIG. 5 illustrates a side view of a driving system of a driving assembly according to an example of the present disclosure.

FIG. 6 schematically represents a motion of an outer shaft and an eccentric pin according to an example of the present disclosure.

FIG. 7 schematically represents a motion of an eccentric pin and a print medium input beam according to an example of the present disclosure.

FIG. 8 schematically represents a sensor assembly according to an example of the present disclosure.

FIG. 9 is a block diagram of an example of a method to adjust a distance between a print medium support and a printhead of a printing system.

### DETAILED DESCRIPTION

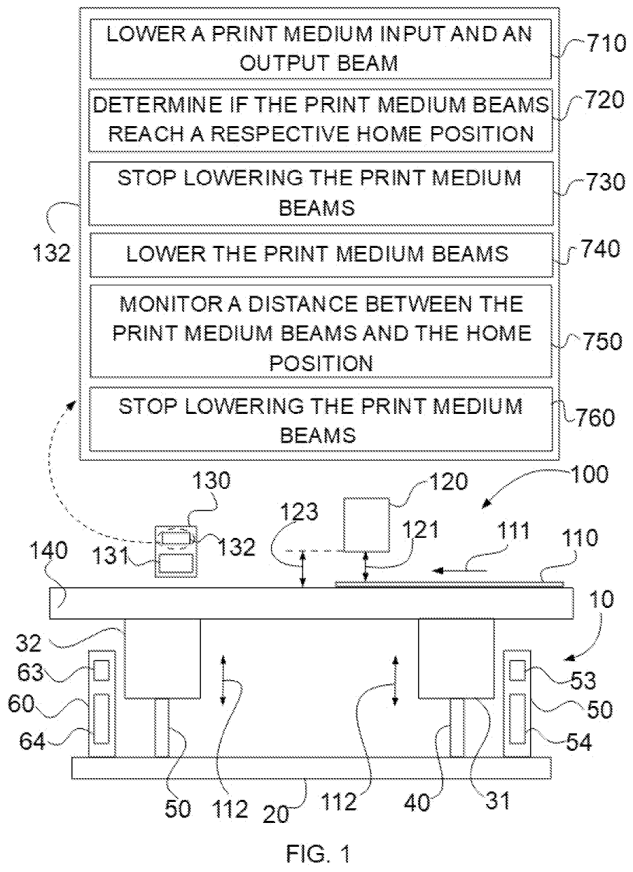

FIG. 1 illustrates a side view of a printing system according to an example of the present disclosure. The printing system 100 comprises a printhead 120 to deliver print agent on a print medium 110, a print medium support 140 to support the print medium 100 advancing in a print medium advance direction 111. The printing system 100 comprises an adjusting system 10 to adjust a distance 123 between the print medium support 140 and the printhead 120.

The printhead 120 may be provided with a plurality of nozzles to deliver print agent, e.g. ink, onto the print medium 110 so as to print an image. During printing, dots of print agent may be precisely delivered onto the print medium 110 at a specific printhead-to-print medium spacing or distance 121. In this disclosure, delivering print agent on a print medium includes firing, ejecting, spitting or otherwise depositing print agent onto the print medium. The printhead may comprise a print agent chamber containing print agent to be delivered onto the print medium.

In some examples, a heating element may cause a rapid vaporization of print agent in a print agent chamber, increasing an internal pressure inside this print agent chamber. This increase in pressure makes a drop of print agent exit from the print agent chamber to the print medium through a nozzle. These printing systems may be called as thermal inkjet printing systems.

In some examples, a piezo electric may be used to force a drop of print agent to be delivered from a print agent chamber onto the print medium through a nozzle. A voltage may be applied to the piezo electric, which may change its shape. This change of shape may force a drop of print agent to exit through the nozzle. These printing systems may be called as piezo electric printing systems.

In some examples, the printhead may be static. The printhead or a plurality of printheads may extend along a width of a print medium, i.e. in a print medium width direction. A printhead may be mounted in a print bar spanning a width of the print medium. The plurality of nozzles may be distributed within the printhead or a plurality of printheads along the width of the print medium. The width of the print medium extends in a print medium width direction. The print medium width direction may be substantially perpendicular to the print medium advance direction. Such an arrangement may allow most of the width of the print medium to be printed simultaneously. These printing systems may be called as page-wide array (PWA) printing systems.

In some examples, the printhead may travel repeatedly across a scan axis for delivering print agent onto a print medium which may advance along a print medium advance direction. The scan axis may be substantially perpendicular to the print medium advance direction. The scan axis may be substantially parallel to print medium width direction. The printhead may be mounted on a carriage for moving across the scan axis. In some examples, several printheads may be mounted on a carriage. In some examples, four printheads may be mounted on a single carriage. In some examples, eight printheads may be mounted on a single carriage.

The print medium support 140 supports the print medium 110 to receive the print agent delivered by the printhead 120. The printhead 120 is above the print medium support 140 and a print zone may be defined therebetween. The print medium support may guide and support the print medium in the print zone during printing. A lower side of the print medium may lie on the print medium support.

The print medium is a material capable of receiving print agent, e.g. ink. The print medium may comprise paper, cardboard, cardstock, textile material or plastic material. The print medium may be a sheet, e.g. a sheet of paper or a sheet of cardboard.

The print medium support may comprise a hold down system to apply a holding force on the print medium to hold down the print medium on the print medium support 140. The hold down system may thus help to flatten the print medium when passes over the print zone. In some examples, hold down system may comprise a vacuum assembly to apply vacuum in the print medium support for flattening the print medium onto the print medium support. The print medium support may be permeable, so as to allow the vacuum through an upper side of the print medium support to pull the print medium against the print medium support. For example, the print medium support may comprise an upper plate having a plurality of through-holes in fluid communication with a vacuum source. The vacuum assembly may suck the print medium towards the print medium support.

In some examples, the printing system may comprise a print medium feed mechanism for feeding print medium to a print zone. The print medium feed mechanism may make the print medium advance in the print medium advance direction.

The printing system of FIG. 1 comprises an adjusting system 10 to adjust a distance 123 between the print medium support 140 and the printhead 120. The adjusting system 10 comprises a support structure 20 and a print medium input beam 31 and print medium output beam 32 to support the print medium support 140. The print medium input beam 31 and the print medium output beam 32 are movable coupled to the support structure 20.

In addition, the adjusting system 10 comprises an input beam driving assembly 40 and an output beam driving assembly 50 to respectively move the print medium input beam 31 and print medium output beam 32 relative to the support structure 20 between an upper and a lower end including a home position.

The adjusting system 10 of FIG. 1 comprises an input beam sensor assembly 50 and an output beam sensor assembly 60. The sensor assemblies 50 and 60 comprise a reference sensor 53 and 63 to respectively detect if the print medium input beam 31 and the print medium output beam 32 are at the home position and a relative sensor 54 and 64 to respectively determine a distance between the print medium input beam 31 and the print medium output beam 32 and the home position.

The adjusting system 10 of FIG. 1 may accurately adjust the distance 123 between the print medium support 140 and the printhead 120 by moving the print medium support 140 relative to the printhead 120 in a Z-direction 112. The printhead 120 may thus be maintained at the same position in the Z-direction 112. Adjusting the distance between the printhead and the print medium support may be simplified. The distance 123 may thus be adapted to different print medium thicknesses by moving the print medium support. A printhead-to-print medium spacing 121 may be set for a given print medium thickness. The distance 123 may also be adapted as a function of a desired print image quality. For example, the print medium support may be adjusted as a function of a print medium composition and/or of a print image category, e.g. photo, graph, poster, CAD (computer aided design) or GIS (image of geographical information). Versatility of the printing system may thus be increased. Providing a sensor assembly and a driving assembly for each of the beams may increase the precision and the flatness of the adjusting system.

Movement of the print medium input beam 31 and of the print medium support beam 32 relative to the support structure 20 is independently driven the input beam driving assembly 40 and the output beam driving assembly 50. The input beam driving assembly 40 may lift and lower the print medium input beam 31 between an upper and a lower end. The output beam driving assembly 50 may lift and lower the print medium output beam 32 between and upper and a lower end. Accordingly, an up and down movement of print medium support may be limited by the motion of the driving assemblies. Mechanical stoppers or bumps to stop the movement of the print medium support when hits a mechanical stopper may be avoided. Therefore, crashes between printing system components may be reduced and the operational life of the adjusting system components may consequently be extended. This may also allow using driving assemblies with motors with high torque and low speed, which may increase the accuracy of the position of the print medium support relative to the printhead, i.e. a distance between the printhead and the print medium support. Consequently, image quality may be enhanced for different types of print media, e.g. different print medium thicknesses, and/or a print image category.

The reference sensor 53 may detect if the print medium input beam 31 is at the home position and the relative sensor 54 may determine a distance travelled by the print medium beam input from the home position. A home position may thus be detected avoiding mechanical stoppers or bumpers. Using a reference sensor to determine a distance travelled by the print medium input beam from the home position may increase the precision of the measurement. In addition, reliability and robustness of the system may be improved and sensor costs may be reduced.

In some examples, the reference sensor of the input beam sensor assembly may comprise an optical sensor at one of the print medium input beam and the support structure and a reference line at the other of the print medium input beam and the support structure. The optical sensor may detect the reference line. Detecting the reference line may indicate that the print medium input beam is at the home position. In some examples, the optical sensor may be coupled to or at the print medium input beam and the reference line coupled to or at the support structure. In some examples, the optical sensor may be coupled to or at the support structure and the reference line coupled to or at the print medium input beam.

In some examples, the reference sensor of the output beam sensor assembly may be according to any of the examples of reference sensors of the input beam sensor assembly.

In some examples, the relative sensor of the input beam sensor assembly comprises a plurality of sensor strips at one of the print medium input beam and the support structure and an optical sensor at the other of the print medium input beam and the support structure. The optical sensor may thus determine the distance travelled by the print medium input beam from the home position by identifying the number of sensor strips crossed when the print medium input beam is lowered. In some examples, the optical sensor may be coupled to or at the print medium input beam and the plurality of sensor strips coupled to or at the support structure. In some examples, the optical sensor may be coupled to or at the support structure and the plurality of sensor strips coupled to or at the print medium input beam.

In some examples, the relative sensor of the output beam sensor assembly may be according to any of the examples of relative sensors of the input beam sensor assembly herein disclosed.

The print medium input beam may extend in an input beam direction, e.g. between a first end portion to a second end portion. The input beam direction may be perpendicular to the Z-direction and to the print medium advance direction. Similarly, the print medium output beam may extend in an output beam direction parallel to the input beam direction.

In some examples, the input beam driving assembly may comprise a first driving system engaging a first end portion of the print medium input beam and a second driving system engaging a second end portion of the print medium input beam. The print medium input beam may thus be lifted and lowered by actuating the first driving system and the second driving system. The first and the second driving system may be independently driven. The print medium input beam may be precisely positioned along the Z-direction.

Similar to the input beam driving assembly, the output beam driving assembly may comprise a first driving system engaging a first end portion of the print medium output beam and a second driving system engaging a second end portion of the print medium output beam.

In some examples, each of the input beam driving assembly and the output beam driving assembly may comprise a first and a second driving system. This may increase flatness and stability of the print medium support. In some examples, the first and the second driving system of each of the input and output beam driving assembly may comprise a drive motor. Less powerful drive motors may thus be used. Accordingly, the adjusting system may be more compact.

In some examples, the input beam sensor assembly may comprise a plurality of reference sensors and a plurality of relative sensors. In some examples, the input beam driving assembly may comprise a first driving system and a second driving system at opposite end portions of the print medium input beam. A first reference sensor and a first relative sensor may be associated with the first driving system. A reference sensor and a relative sensor may form a sensor system. A second reference sensor and a second relative sensor may be associated with the second driving system. Accordingly, a detection of the movement provided by each of driving system may be enhanced.

In some examples, the output beam sensor assembly may be according to any of the examples of input beam sensor assemblies herein disclosed. For example, a first reference sensor and a first relative sensor, i.e. a first sensor system, may be associated with a first driving system of the output beam sensor assembly by sensing a movement provided by the first driving system to the print medium output beam. A second reference sensor and a second relative sensor, i.e. a second sensor system, may sense a movement provided by a second driving system to the print medium output beam. Position of opposite ends of the print medium output in the Z-direction be may thus be precisely set. Flatness of the print medium support may thus be improved.

The printing system 10 of FIG. 1 further comprises a controller 130 to control the operation of the adjusting system 10. In some examples, the controller may further control the operation of the printing system.

In FIG. 1 the controller 130 includes a processor 131 and a non-transitory machine-readable storage medium 132. The non-transitory machine-readable storage medium 132 is coupled to the processor 131.

The processor 131 performs operations on data. In an example, the processor is an application specific processor, for example a processor dedicated to control the adjusting system. The processor 131 may also be a central processing unit.

The non-transitory machine-readable storage medium 132 may include any electronic, magnetic, optical, or other physical storage device that stores executable instructions. The non-transitory machine-readable storage medium 132 may be, for example, Random Access Memory (RAM), an Electrically Erasable Programmable Read-Only Memory (EEPROM), a storage drive, an optical disk, and the like.

FIG. 1 additionally comprises a zoom-in view schematically representing an example of a non-transitory machine-readable storage medium 132 according to one example of the present disclosure. The non-transitory machine-readable storage medium is encoded with instructions which, when executed by the processor 131, cause the processor 131 to lower a print medium input beam 31 and a print medium output beam 32 supporting the print medium support 140 from a safety distance between the print medium support 140 and a printhead 120 as represented at block 710, determine if the print medium input beam 31 and the print medium output beam 32 reaches a respective home position as represented at block 720, stop lowering the print medium input beam 31 and the print medium output beam 32 when the respective home positions are detected as represented at block 730, lower the print medium input beam 31 and the print medium output beam 32 from the respective home positions as represented at block 740, monitor a distance between the print medium input beam 31 and the print medium output beam 32 from the respective home positions when the print medium input beam 31 and the print medium output beam are lowered as represented at block 750 and stop lowering the print medium input beam 31 and the print medium output beam 32 when a respective printing position is detected for each of the print medium input beam 31 and the print medium output beam 32 as represented at block 760.

At block 710, the print medium input beam may be lowered by actuating an input beam driving assembly. In some examples, actuating an input beam driving assembly may comprise actuating a pair of driving systems at opposite ends of the print medium input beam. In some examples, the safety distance between the print medium support and the printhead may be an upper end limited by the actuation of the input beam driving assembly. Crashes against the printhead or other components of the printing systems may thus be prevented. The print medium output beam may be lowered in a similar way.

In some examples, the print medium input beam and the print medium output beam may be lifted from an initial position to a safety position at which the print medium support is at a safety distance relative to the printhead.

At block 720, a sensor may detect if the print medium input beam and the print medium output beam are at a home position. For example, a reference sensor of an input beam sensor assembly, i.e. an input beam reference sensor, according to any of the examples herein disclosed may determine if the print media input beam is at the home position.

In some examples, determining if the print medium input beam and the print medium output beam reaches a respective home position may comprise receiving data from an input beam reference sensor and from an output beam reference sensor respectively indicating if the print medium input beam and the print medium output beam are at the home position.

For example, the input beam reference sensor may comprise an optical sensor and a reference line. The optical sensor may detect the reference line when the print medium input beam is lowered from the safety line. Detecting the reference line may thus indicate that the print medium input beam is at the home position. In some examples, a plurality of input beam reference sensors may indicate if several portions of the print medium input beam are at the home position. The home position of the print medium output beam may be determined in a similar way.

At block 730, the print medium input beam and the print medium output beam may be stopped at the home position. The processor may receive data from reference sensors associated with each of print medium input and output beams. This data may indicate that the print medium input and output beams are at their respective home positions. Then, the processor may actuate the respective driving assemblies to stop the movement of the print medium input beam and the print medium output beam at their respective home positions. The print medium input beam and the print medium output beam may be maintained at the home positions during a predetermined period of time to enhance the flatness of the print medium support. A self-locking transmission of the driving assemblies may prevent the print medium input and output beams from lowering.

After ensuring the home position for the print medium input beam and the print medium output beam, the processor 132 may lower the print medium input and output beam as represented at block 740. For example, where input beam reference sensor or sensors are to determine if the input beam are at the home position, the print medium input beam may start lowering the print medium input beam after each of the input beam reference sensors indicate that the print medium input beam is at the home position. Home position for the print medium input beam may thus be reliably determined.

The print medium input beam and the print medium output beam may be lowered by actuating a respective input and output beam driving assemblies. The print medium input and output beam may be lowered according to any of the examples herein disclosed, for example, as described with respect to block 710.

At block 750 a distance travelled by each of the print medium input and output beams may be monitored when are lowered from their respective home positions is represented. The position of the print medium input and output beams relative to their home positions may thus be precisely monitored. A distance increase may be monitored by a relative sensor according to any of the examples herein disclosed.

In some examples, monitoring a distance between the print medium input beam and the print medium output beam from the respective home positions may comprise receiving data from an input beam relative sensor and from an output beam relative sensor respectively counting the number of sensor strips detected by each of the relative sensors. Counting the number of sensor strips detected by a relative sensor may indicate a distance travelled by a print medium input and/or output beam from the home position. In some examples, a plurality of input beam relative sensors may monitor a distance between the print medium input beam from the home position, e.g. a distance between portions of the print medium input beam. Similarly, a plurality of output beam relative sensors may be used for monitoring a distance between the print medium output beam and the home position.

Block 760 may represent positioning the print medium input beam and the print medium output beam at a respective printing position. As the processor monitors a distance between the print medium input and output beams, the print medium input and output beams may be stopped at a respective printing position. A printing position of a print medium input or output beam correspond to the position of these beams at which the printhead and the print medium support are at a distance to ensure a predetermined printhead-to-print medium spacing. Such a predetermined printhead-to-print medium spacing may be set for a given print medium thickness and/or for a given print medium composition and/or for a given print image category.

In some examples, the non-transitory machine-readable storage medium 132 may further cause the processor 131 to obtain a print medium thickness and determine the printing position of the print medium input beam and of the print medium output beam based on the obtained print medium thickness. A dedicated sensor may be measured the print medium thickness before reaching a print zone. In some examples, a print medium thickness may be provided by a user via a user interface device coupled to the processor. In some examples, the non-transitory machine-readable storage medium may cause the processor to obtain a print medium composition and determine the printing position of the print medium input beam and of the print medium output beam based on the obtained print medium composition. In some examples, the non-transitory machine-readable storage medium may cause the processor to obtain a print image category and determine the printing position of the print medium input beam and of the print medium output beam based on the obtained print image category.

The instructions encoded in the non-transitory machine-readable storage medium for the processor represented at blocks 710, 720, 730, 740, 750 and 760 may participate in adjusting a distance between a printhead and print medium support of a printing system.

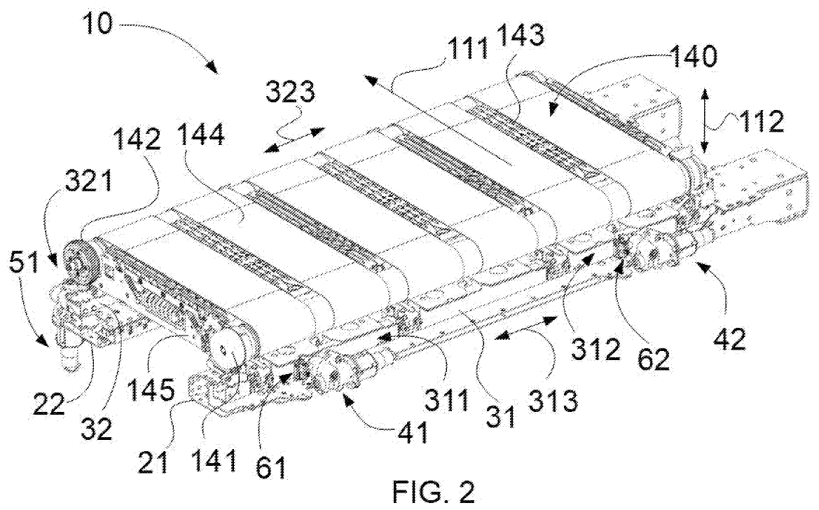

FIG. 2 illustrates an isometric view of an adjusting system according to an example of the present disclosure. The adjusting system 10 comprises a support structure and a print medium input beam 31 and a print medium output beam 32 to support the print medium support 140. The print medium input beam 31 and the print medium output beam 32 are movably coupled to the support structure. In this figure, the support structure comprises an input support structure 21 and an output support structure 22. The print medium input beam 31 may be movably coupled to the input support structure 21 and the print medium output beam 32 may be movably coupled to the output support structure 22.

The print medium input beam 31 and the print medium output beam 32 may be moved in a Z-direction 112. The print medium support 140 of this figure is coupled to the print medium input beam 31 and to the print medium output beam 32. Accordingly, the print medium support 140 may be moved in the Z-direction 112.

In this example, the print medium input beam 31 extends from a first end portion 311 to a second end portion 312 in an input beam direction 313. The print medium output beam 32 extends between a first end portion 321 to a second end portion in an output beam direction 323. The input beam direction 313 may be parallel to the output beam direction 323.

The adjusting system of FIG. 2 further comprises an input beam driving assembly and an output beam driving assembly to respectively move the print medium input beam 31 and the print medium output beam 32 relative to the support structure, e.g. relative to the input support structure 21 and to the output support structure 22, between an upper and a lower end including a home position. In this example, the input beam driving assembly comprises a first driving system 41 engaging a first end portion 311 of the print medium input beam 31 and a second driving system 42 engaging a second end portion 312 of the print medium input beam 31. In this figure, the output beam driving assembly comprises a first driving system 53 engaging a first end portion 321 of the print medium output beam 32 and a second driving system (not shown in FIG. 2) engaging a second end portion of the print medium output beam 32.

Furthermore, the adjusting system of FIG. 2 comprises an input beam sensor assembly and an output beam sensor assembly. In this figure, the input beam sensor assembly comprises a first sensor system 61 and a second first sensor 62. In this example, the first sensor system 61 is associated with the first driving system 41 and the second sensor system 62 is associated with the second driving system 42.

In FIG. 2, the first sensor system 61 and the second sensor system 62 comprise a reference sensor to detect if the print medium input beam 31 is at the home position. For example, the reference sensor of the first sensor system 61 may detect if the first end 311 of the print medium input beam 31 is at the home position. In this figure, the first sensor system 61 and the second sensor system 62 comprise a relative sensor to determine a distance between the print medium input beam 31 and the home position.

The output sensor assembly may comprise a first sensor system and a second sensor system. The first and the second sensor system may comprise a reference sensor to detect if the print medium output beam 32 is at the home position and a relative sensor to determine a distance between the print medium output beam 32 and the home position. The reference sensors and the relative sensors of the output beam sensor assembly may be according to any of the examples of reference sensors and relative sensors herein disclosed.

In this figure, a pair of driving systems move the print medium input beam and a pair of driving systems move the print medium output beam. The print medium input and output beams may thus be precisely supported and moved. Accordingly, a distance between the print medium support and a printhead may be accurately adjusted. Power of drive motors actuating the driving systems may be reduced and reliability of the system may be improved. A reference sensor and a relative sensor may be associated to each of the driving systems. Movement provided by each of the driving system may be measured. The driving systems may thus be independently controlled to ensure a flatness of the print medium support.

In FIG. 2, the print medium support 140 may support print medium advancing in a print medium advance direction 111. In this example, the print medium support 140 comprises a print medium input roller 141 and a print medium output roller 142. The print medium input roller 141 may be at an opposite side of the print medium support 140 along a print medium advance direction 111. In some examples, the print medium input roller may be rotatably coupled to the print medium input beam and the print medium output roller may be rotatably coupled to the print medium output beam.

The print medium input roller 141 may rotate about an axis parallel to an input beam direction 313 and the print medium output roller 142 may rotate about an axis parallel to the output beam direction 323. The input beam direction 313 may be parallel to the output beam direction 323.

A belt or a plurality of belts 143 may engage the print medium input roller 141 and the print medium output roller 142. In this example, the print medium output roller 142 may be rotated to cause a displacement of the belts 143. Supporting plates 144 may be between belts to contact the print medium. Print medium may be supported by the supporting plates and by the belts. A displacement of the belts 142 may cause a displacement of the print medium. The print medium may thus advance in the print medium advance direction by the displacement of the belts. In some examples, the supporting plates and/or the belts may comprise a plurality of through-holes in fluid communication with a vacuum source to hold down a print medium towards the supporting plates.

In FIG. 2, the adjusting system comprises a connecting structure 145 connecting the print medium input beam 31 to the print medium output beam 32. The connecting structure 145 may comprise a plurality of connecting beams extending in a direction parallel to the print medium advance direction 111. The connecting beams may be flexibly connected to the print medium input beam and to the print medium output beam. This may increase the flexibility of the print medium support. For example, the flexible connection between the adjusting system and the print medium beams may compensate deformations or misalignments caused by a delay between the driving systems moving the print medium beams.

In some examples, a column or a plurality of columns may be connected the support structure to guide the up and down movement of the print medium input beam and of the print medium output beam. A bushing assembly may be between the column and the print medium input and output beams. The bushing assembly may absorb misalignments of the print medium input and output beam. For example, a pair of columns may guide the up and down movement of the print medium input beam and a bushing assembly may between each of the columns and the print medium input beam. These bushing assemblies may absorb inclinations and/or deformations of the print medium input beam.

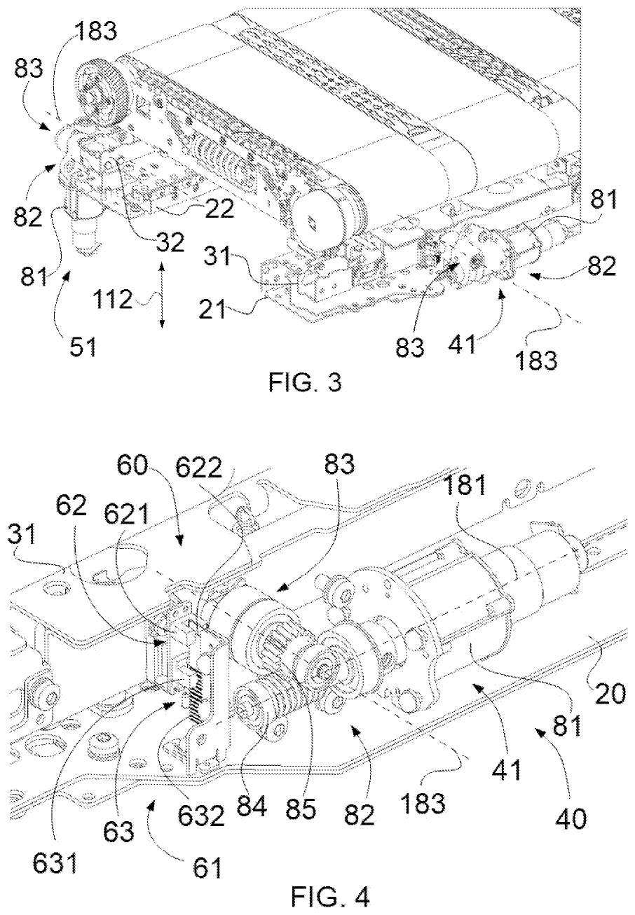

FIG. 3 illustrates a zoom-in view of a portion of the adjusting system of FIG. 2. FIG. 3 shows a first driving system 41 of the input driving assembly and first driving system 51 of the output driving assembly. Other driving system of the adjusting system may be according to the first driving system 41 described herein.

The first driving system 41 of this figure is connected to the input support structure 21 and may induce an up and down movement of the print medium input beam 31 relative to the input support structure 21. Similarly, the first driving system 51 of the output beam driving assembly may be connected to the output support structure 22 to cause an up and down movement of the print medium output beam 32 relative to the output support structure 22.

In FIG. 3, the first driving system 41 comprises a drive motor 81 and a transmission 82 to transmit a driving force from the drive motor 81 to the print medium input beam 31. The transmission 82 of this figure includes an outer shaft 81 rotatably about an outer shaft direction 183. The driving force may cause the rotation of the outer shaft 83. The outer shaft 83 may engage the print medium input beam 31 to cause the up and down movement. In this example, the outer shaft direction 183 is perpendicular to the rotational axis of the drive motor 81. The rotational axis of the drive motor of the first driving system 41 is parallel to the input beam direction and the outer shaft direction 183 is parallel to the print medium advance direction.

In some examples, the transmission may include a self-locking transmission to lock the position of the print medium input beam. Accordingly, a position of the print medium input beam may be maintained in absence of a driving force provided by the input beam driving assembly. Furthermore, external retention or braking systems to hold the print medium input beam in a predetermined position, i.e. at a predetermined height, may be avoided.

Similar to the first driving system 41 of the input beam driving assembly, the first driving system 51 of the output driving assembly of this figure comprises a drive motor 81 and a transmission 82 to transmit a driving force from the drive motor 81 to the print medium output beam 32. The transmission 82 includes an outer shaft 81 rotatably about an outer shaft direction 183 perpendicular to rotational axis of the drive motor 81. However, the rotational axis of the drive motor 51 of the first driving system 51 of the print medium outer beam is parallel to Z-direction 112.

In some examples, the driving systems may comprise a gearbox to reduce the rotational speed provided by the drive motor and increase the torque. Accordingly, higher torque may be provided which may increase the capacity the lift heavier loads, e.g. heavier print medium supports. Lower speeds may increase the accuracy of the movements of the print medium support

FIG. 4 illustrates a driving system of a driving assembly and a sensor system of a sensor assembly according to an example of the present disclosure. The driving assembly illustrated in this figure is an input beam driving assembly and the sensor assembly is an input beam sensor assembly. However, an output beam driving assembly and an output beam sensor assembly may be according to any of the examples described with respect to FIG. 4.

The input beam driving assembly 40 of this figure comprises an input beam driving system 41 comprising a drive motor 81 and a transmission 82 to transmit a driving force from the drive motor 81 to the print medium input beam 31. The transmission 82 may transform a rotational movement provided by the drive motor 81 to a linear movement to lift and lower the print medium input beam 31 relative to the support structure 20.

In FIG. 4, the transmission 82 comprises a worm drive mechanism having a worm screw 84 driven by the drive motor 81 and a worm wheel 85 coupled to an outer shaft 83. The worm screw 84 meshes the worm wheel 85 so as to transmit a driving force from the drive motor 81 to the outer shaft 83. A worm drive mechanism may reduce rotational speed and transmit higher torque. The worm screw 84 may rotate about a rotational axis 181 of the drive motor and the worm wheel 85 about an outer shaft direction 183. In this figure, the rotational axis 181 of the drive motor is perpendicular to the outer shaft direction 183. Motion may thus be transferred in 90 degrees. The driving assembly may thus be more compact.

A worm drive mechanism may be an example of a self-locking transmission as only rotation may be transmitted from the worm screw 84 driven to the worm wheel 85.

In some examples, the driving system may comprise an eccentric pin protruding from the outer shaft in a direction parallel to the outer shaft direction. The worm wheel may be coupled at one end of the outer shaft and the eccentric pin may protrude from the opposite end. The eccentric pin may engage the print medium input beam to transform a rotational motion to a linear motion.

In some examples, the input beam driving assembly may comprise a plurality of driving systems according to any of the examples herein disclosed. The output beam driving assembly may be according to any of the examples of input beam driving assemblies herein disclosed.

The input beam sensor assembly 60 of this figure comprises a sensor system 61 including a reference sensor 62 and a relative sensor 63.

In this example, the reference sensor 62 comprises an optical sensor 621 coupled to the print medium input beam 31 and a reference line 622 coupled to the support structure 20.

In FIG. 4, the relative sensor 63 comprises an optical sensor 631 coupled to the print medium input beam 31 and a plurality of sensor strips 634 coupled to the support structure 20.

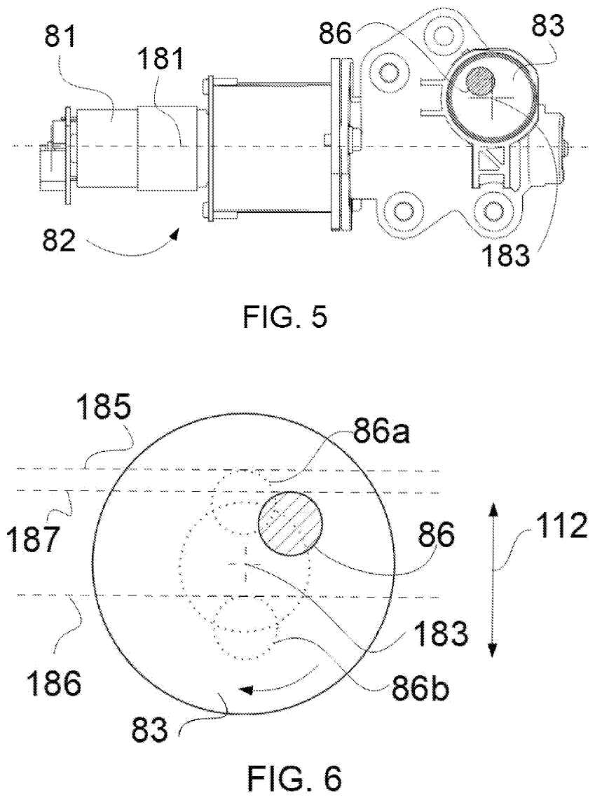

FIG. 5 illustrates a side view of a driving system of a driving assembly, e.g. of an input beam driving assembly and/or of an output beam driving assembly, according to an example of the present disclosure. This figure illustrates a side of a driving system facing print medium input or output beam.

The driving system of this figure comprises a drive motor 81 and a transmission 82 to transmit a driving force from the drive motor 81 to the print medium input or output beam. The transmission comprises an outer shaft 83 rotatably about an outer shaft direction 183. In this figure, the outer shaft direction 183 is perpendicular to the paper. In this figure, the rotational axis 181 of the drive motor is perpendicular to the outer shaft direction 183.

In this figure, an eccentric pin 86 protrudes from the outer shaft in a direction parallel to the outer shaft direction (perpendicular to the paper). The eccentric pin may engage a print medium input or output beam to transform a rotational motion to a linear motion. The eccentric pin and a slot comprised in the print medium input or output beam may form a Scotch yoke (also known as slotted link mechanism). A Scotch yoke is a reciprocating motion mechanism that converts a rotational motion to a linear motion.

The center of the eccentric pin of this figure is separated from the outer shaft direction. In this example the eccentric pin comprises a cylindrical shape.

FIG. 6 schematically illustrates a motion of an outer shaft and an eccentric pin according to an example of the present disclosure. The outer shaft 83 rotates about an outer shaft direction 83. An eccentric pin 86 protrudes from the outer shaft in a direction parallel to the outer shaft direction 183. In this example, the eccentric pin rotates together with the outer shaft 83 and may adopt different positions during rotation.

In this figure, the eccentric pin 86 is at the home position 187, the eccentric pin 86a is at a top dead center position 185 and the eccentric pin 86b at a bottom dead center position 186. Accordingly, the eccentric pin may be moved between a top dead center position 185 and a bottom dead center position 186 in a Z-direction 112. The eccentric pin at the home position is between the top dead center position 185 and the bottom dead center position 186. Movements of the eccentric pin in the Z-direction may thus be limited between the top dead center position and the bottom dead center position.

In some examples, a distance between the top dead center position 185 and the bottom dead center position 186 may be between 5 mm and 30 mm. In some examples, a distance between the top dead center position 185 and the bottom dead center position 186 may be between 8 mm and 20 mm.

In some examples, a distance between the top dead center position 185 and the home position 187 in a Z-direction 112 may be between 0.5 mm and 5 mm. In some examples, a distance between the top dead center position 185 and the home position 187 in a Z-direction 112 may be between 0.8 mm and 3 mm.

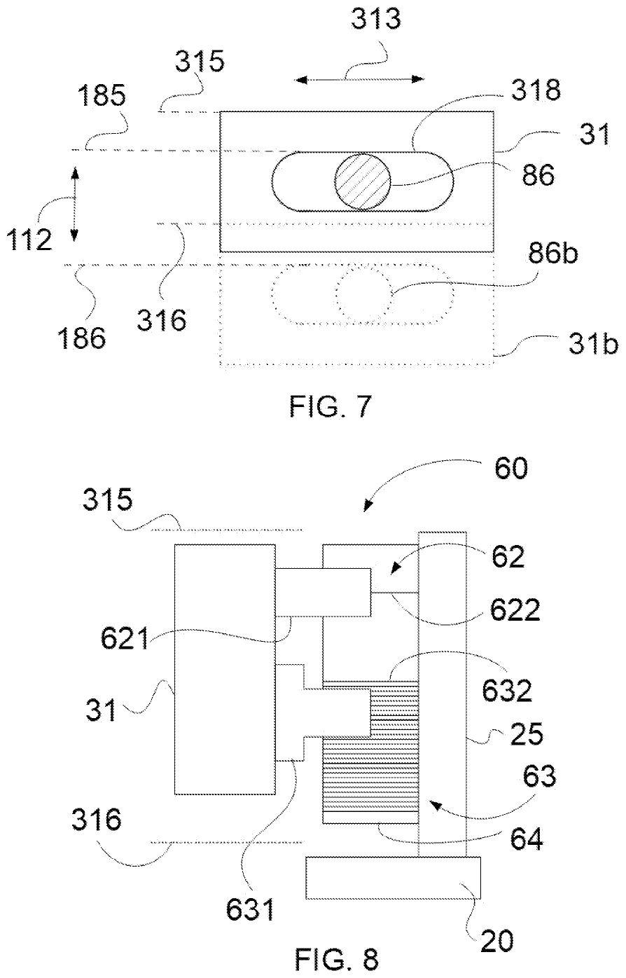

FIG. 7 schematically represents a motion of an eccentric pin and a portion of a print medium input beam according to an example of the present disclosure. An eccentric pin 86 having a rotational motion engages with a print medium input beam 31. The eccentric pin extends in a direction parallel to the outer shaft direction (see for example FIG. 6). In some examples, the eccentric pin 86 may engage with a print medium output beam rather than with the print medium input beam.

The print medium input beam 31 of this figure extends in an input beam direction 313. The input beam direction is perpendicular 313 to the outer shaft direction. In this figure, the print medium input beam 31 comprises a slot 318 extending in a direction parallel to the input beam direction 313 to receive the eccentric pin 86 to transmit a driving force from the outer shaft to the print medium input beam 31.

In this figure, the eccentric pin 86 rotates together with an outer shaft (not shown in this figure). In FIG. 7, the eccentric pin 86 is at a top dead center position 185 and the eccentric pin 86b at the bottom dead center position 186. The eccentric pin 86 may thus rotate between the top dead center position 185 and bottom dead center position 186.

In FIG. 7, the eccentric pin is inserted into the slot 318. The eccentric pin 86 and the slot 318 may form a Scotch yoke mechanism. The eccentric pin may slide inside the slot in a direction parallel to the input beam direction 313 but may cause an up and down movement of the print medium input beam 31 in the Z-direction 112. When the eccentric pin rotates, the pin may contact an upper and/or a lower surface of the slot to transform a rotational motion to a linear motion.

Accordingly, the eccentric pin 86 may cause an upwards and downwards movement of the print medium input beam between an upper end 315 and a lower end 316.

In this figure, the print medium input beam 31 is at the upper end 315. When the eccentric pin 86 is at the top dead center position 185, the print medium input beam 31 is at the upper end 315. This figure also shows a print medium input beam 31b at a lower end 316 when the eccentric pin 86b is at the bottom dead center position 186.

Accordingly, the rotational movement of the eccentric pin may induce a linear movement of the print medium input beam in a Z-direction 112. The upwards and downwards movements of the print medium input beam may thus be constrained between the upper end and the lower end. The print medium input beam 31 may thus be moved between an upper end 315 and a lower end 316 to adjust a distance between the print medium support and a printhead.

In some examples, the distance between top dead center position 185 and the bottom dead center position 186 may be substantially the same than between the upper end 315 and the lower end 316 of the print medium input beam 31.

FIG. 8 schematically represents a sensor assembly according to an example of the present disclosure. The sensor assembly illustrated in this figure is an input beam sensor assembly. The input beam sensor assembly 60 comprises a reference sensor 62 and a relative sensor 63 forming a sensor system. In some examples, the input beam sensor assembly may comprise a plurality of sensor systems having a reference sensor and a relative sensor.

In this example, the reference sensor 62 comprises an optical sensor 621 coupled to the print medium input beam 31 and a reference line 622 coupled to the support structure 20. The reference line 622 may be integrated in a plate 64. A bracket 25 may be used for coupling the reference line 622 to the support structure 20, e.g. the bracket 25 support the plate 64 comprising the reference line 622.

In some examples, the optical sensor of the reference sensor may be at or coupled to the support structure and the reference line may at or coupled to the print medium beam, e.g. to the print medium input or output beam.

The optical sensor 621 of the reference sensor 62 may detect the reference line 622. When the optical sensor 621 reads the reference line 622, the print medium input beam is at the home position. The print medium input beam may thus be stopped when the optical sensor of the reference sensor when detects the reference line, i.e. at the home position.

In FIG. 8, the print medium input beam 31 is at the home position. The print medium input beam 31 may be moved between an upper end 315 and a lower end 316 to adjust a distance between the print medium support and a printhead.

In some examples, the input beam sensor assembly may comprise a quadrature encoder sensor to detect a direction of the movement of the print medium input beam relative to the support structure. In some examples, a quadrature encoder sensor may be integrated with the reference sensor. In some examples, a quadrature encoder sensor may be integrated with the relative sensor. In some examples, a quadrature encoder sensor may be independent from the reference sensor and from the relative sensor.

In FIG. 8, the relative sensor 63 comprises an optical sensor 631 coupled to the print medium input beam 31 and a plurality of sensor strips 632 at the support structure 20. The plurality of sensors strips 632 may be in the plate 64. The plate 64 may be supported by the bracket 25.

The relative sensor may monitor a distance travelled by the print medium input beam from the home position.

The optical sensor 631 of the relative sensor may comprise a linear incremental encoder. The linear incremental encoder may report position changes of the print medium input beam. Number of sensor strips crossed may thus be counted. The linear incremental encoder may comprise a quadrature encoder sensor to indicate the detection of a sensor strip and the direction of the movement. A linear incremental encoder comprising a quadrature encoder sensor may be called as a quadrature linear incremental encoder. A relative distance and a direction of the movement may thus be determined. Accordingly, the quadrature linear incremental encoder may detect if the print medium input beam is lifted or lowered.

Using a quadrature linear incremental encoder may increase the precision of the detection.

Information provided by the quadrature linear incremental encoder of the relative sensor may be used in the detection of the reference line. The input beam sensor assembly may thus distinguish detecting the reference line when the print medium input beam moves in an upwards direction from when it moves in a downwards direction. For example, this may allow stopping the print medium input beam when the reference line is detected at lowering the print medium input beam but not when the reference line is detected at lifting the print medium input beam.

In this example, the quadrature lineal incremental encoder is integrated with the optical sensor 631 of the relative sensor. In some examples, a quadrature lineal incremental encoder may be independent from the optical sensor 631. For example, a quadrature linear incremental encoder may be comprised in the optical sensor 621 of the reference sensor 62.

In some examples, the plurality of sensor strips 632 may comprise a resolution of 150 LPI (150 lines per inch). Distance between sensor strips may thus be about 170 μm (170 micrometers). If the optical sensor 631 of the relative sensor comprises a quadrature linear incremental encoder the measurement resolution may be about 42 μm (42 micrometers). This measurement resolution may provide a precise information of the position of the print medium input beam.

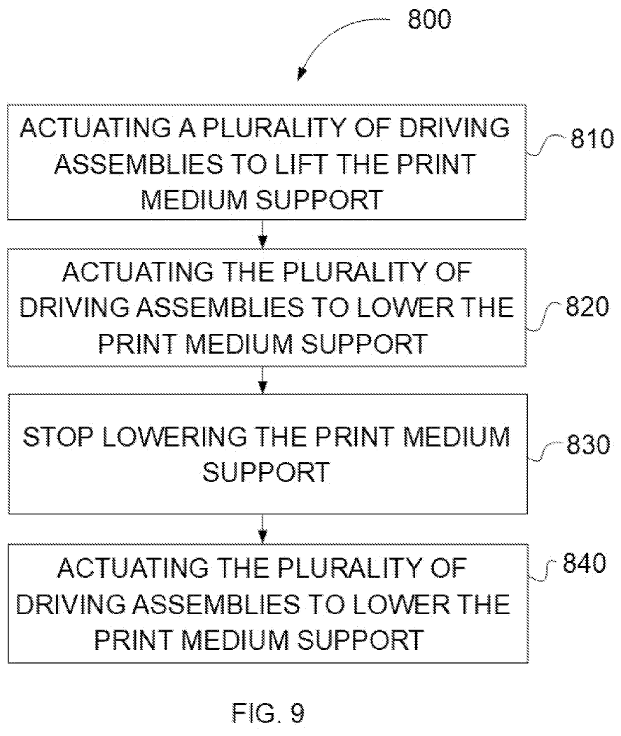

FIG. 9 is a block diagram of an example of a method to adjust a distance between a print medium support and a printhead of a printing system. The method 800 comprises actuating a plurality of driving assemblies to lift the print medium support to a minimum predetermined distance between the print medium support and the printhead as represented at block 810, actuating the plurality of driving assemblies to lower the print medium support as represented at block 820, stopping the plurality of driving assembly when the print medium support reaches a home position during lowering the print medium support as represented at block 830 and actuating the plurality of driving assemblies to lower the print medium support to a printing position as represented at block 840.

In some examples, the method to adjust a distance between a print medium support and a printhead of a printing system may use an adjusting system according to any of the examples herein disclosed. For example, the driving assemblies may be according to any of the examples herein disclosed.

A non-transitory machine-readable storage medium according to any of the examples herein disclosed may comprise instructions to perform this method.

At block 810, the print medium support is lifted to a minimum predetermined distance between the print medium support and the printhead. For example, an input beam driving assembly and an output beam driving assembly may respectively lift a print medium input beam and a print medium output beam supporting the print medium support. In some examples, the print medium input beam and the print medium output beam may be lifted to an upper end according to any of the examples herein disclosed to lift the print medium support to the minimum predetermined distance.

After reaching the minimum predetermined distance, the print medium support may be lowered by actuating the plurality of driving assemblies as represented at block 820.

At block 830, plurality of driving assemblies is stopped when the print medium support reaches a home position during lowering the print medium support. The print medium support may thus be stopped at the home position to ensure a print medium support flatness.

In some examples, the method may comprise determining if the print medium support is at a home position. The home position may be determined by using a sensor according to any of the examples herein disclosed. For example, by using a reference sensor comprising an optical sensor to detect a reference line.

As represented at block 840 the print medium support may be lowered to a printing position. After ensuring that the print medium support is at the home position, the plurality of driving assemblies may be actuated to lower the print medium support to a printing position.

A sensor may provide a feedback about the position of the print medium support relative to the home position. In some examples, the method may comprise determining a distance travelled by the print medium support from the home position when the plurality of driving assemblies is lowering the print medium support from the home position to the printing position.

In some examples, a relative sensor according to any of the examples herein disclosed may be used for determining the distance travelled from the home position. For example, determining a distance travelled by the print medium support from the home position may comprise counting a number of sensors strips in a fixed structure detected by an optical sensor connected to the print medium support. Number of sensor strips crossed may thus be counted. Accordingly, the distance travelled may be determined. The optical sensor and the sensor strips may be according to any of the examples herein disclosed.

The preceding description has been presented to illustrate and describe certain examples. Different sets of examples have been described; these may be applied individually or in combination, sometimes with a synergetic effect. This description is not intended to be exhaustive or to limit these principles to any precise form disclosed. Many modifications and variations are possible in light of the above teaching. It is to be understood that any feature described in relation to any one example may be used alone, or in combination with other features described, and may also be used in combination with any features of any other of the examples, or any combination of any.

1. An adjusting system to adjust a distance between a print medium support and a printhead of a printing system, the adjusting system comprising:
a support structure;
a print medium input beam and a print medium output beam to support the print medium support, the print medium input beam and the print medium output beam being movably coupled to the support structure;
an input beam driving assembly and an output beam driving assembly to respectively move the print medium input beam and the print medium output beam relative to the support structure between an upper and a lower end including a home position; and
an input beam sensor assembly and an output beam sensor assembly, the sensor assemblies comprising:
a reference sensor to respectively detect if the print medium input beam and the print medium output beam are at the home position; and
a relative sensor to respectively determine a distance between the print medium input beam and the print medium output beam and the home position.

2. The adjusting system according to claim 1, wherein the input beam driving assembly comprises a driving system, the driving system comprising:
a drive motor; and
a transmission to transmit a driving force from the drive motor to the print medium input beam, the transmission including an outer shaft rotatably about an outer shaft direction.

3. The adjusting system according to claim 2, wherein the driving system of the input beam driving assembly further comprises an eccentric pin protruding from the outer shaft in a direction parallel to the outer shaft direction.

4. The adjusting system according to claim 3, wherein the print medium input beam extends in an input beam direction perpendicular to the outer shaft direction, and wherein the print medium input beam comprises a slot extending in a direction parallel to the input beam direction to receive the eccentric pin to transmit the driving force from the outer shaft to the print medium input beam.

5. The adjusting system according to claim 2, wherein the transmission comprises a worm drive mechanism having a worm screw driven by the drive motor and a worm wheel coupled to the outer shaft.

6. The adjusting system according to claim 1, wherein the input beam driving assembly comprises a self-locking transmission to lock the position of the print medium input beam.

7. The adjusting system according to claim 1, wherein the input beam driving assembly comprises a first driving system engaging a first end portion of the print medium input beam and a second driving system engaging a second end portion of the print medium input beam.

8. The adjusting system according to claim 1, wherein the reference sensor of the input beam sensor assembly comprises:
an optical sensor coupled to or at one of the print medium input beam and the support structure; and
a reference line coupled to or at the other of the print medium input beam and the support structure.

9. The adjusting system according to claim 1, wherein the input beam sensor assembly comprises a quadrature encoder sensor to detect a direction of the movement of the print medium input beam relative to the support structure.

10. The adjusting system according to claim 1, wherein the relative sensor of the input beam sensor assembly comprises:
a plurality of sensor strips coupled to or at one of the print medium input beam and the support structure; and
an optical sensor coupled to or at the other of the print medium input beam and the support structure.

11. A method to adjust a distance between a print medium support and a printhead of a printing system, the method comprising:
actuating a plurality of driving assemblies to lift the print medium support to a minimum predetermined distance between the print medium support and the printhead;
actuating the plurality of driving assemblies to lower the print medium support;
stopping the plurality of driving assemblies when the print medium support reaches a home position during lowering the print medium support;
actuating the plurality of driving assemblies to lower the print medium support to a printing position.

12. The method according to claim 11, further comprising determining if the print medium support is at a home position.

13. The method according to claim 11, further comprising determining a distance travelled by the print medium support from the home position when the plurality of driving assemblies is lowering the print medium support from the home position to the printing position.

14. The method according to claim 13, wherein determining a distance travelled by the print medium support from the home position comprises counting a number of sensors strips in a fixed structure detected by an optical sensor connected to the print medium support.

15. A non-transitory machine-readable storage medium encoded with instructions which, when executed by a processor, cause the processor to:
lower a print medium input beam and a print medium output beam supporting the print medium support from a safety distance between the print medium support and a printhead;
determine if the print medium input beam and the print medium output beam reaches a respective home position;
stop lowering the print medium input beam and the print medium output beam when the respective home positions are detected;
lower the print medium input beam and the print medium output beam from the respective home positions;
monitor a distance between the print medium input beam and the print medium output beam from the respective home positions when the print medium input beam and the print medium output beam are lowered.
stop lowering the print medium input beam and the print medium output beam when a respective printing position is detected for each of the print medium input beam and the print medium output beam.
